(19) United States
(12) Patent Application Publication
(10) Pub. No.: US 2026/0236032 A1
(43) Pub. Date: Aug. 13, 2026

(54) PLANNING IN MOBILE ROBOTS

(71) Applicant: Five AI Limited, Cambridge (GB)

(72) Inventors: Ludovico Carozza, Cambridge (GB); Majd Hawasly, Cambridge (GB); Mihai-Sorin Dobre, Cambridge (GB); John Redford, Cambridge (GB); Subramanian Ramamoorthy, Cambridge (GB)

(73) Assignee: Five AI Limited, Cambridge (GB)

(21) Appl. No.: 19/156,368

(22) PCT Filed: Feb. 13, 2024
(86) PCT No.: PCT/EP2024/053638

§ 371 Date: Aug. 13, 2025

(30) Foreign Application Priority Data
Feb. 14, 2023 (GB) 2302097.7

(51) Int. Cl. G05D 1/633; G05D 1/644

(52) U.S. Cl. CPC G05D 1/633; G05D 1/644

(57) ABSTRACT

A computer-implemented method of planning an ego trajectory for an ego robot in an environment in the presence of an occluding object, the method comprising: determining a trajectory cost function having one or more planning variables that define a planned ego trajectory, the planning variables tuneable to modify the planned ego trajectory, wherein the trajectory cost function is dependent on a predicted occluded region of the environment, as defined by the planned ego trajectory and a predicted state of the occluding object; and tuning the planning variables using an optimizer applied to the trajectory cost function, wherein the trajectory cost function encodes: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from the perspective of the ego robot, whereby the optimiser is incentivised to tune the planning variables in a manner satisfying the progress objective and the visibility objective.

### TECHNICAL FIELD

The present invention relates to planning systems and methods in autonomous vehicles and other mobile robots.

### BACKGROUND

A rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

Driving decisions in AVs and other mobile robots depend on a number of factors, including progress, safety and comfort. Some existing planners use constrained optimisation techniques to optimise a cost function so as to satisfy constraints on safety, progress, comfort, as well as physical feasibility. One example of a constrained optimisation-based planner is disclosed in earlier International Patent Publication No. WO2021/152050, which is incorporated herein by reference in its entirety. This planner implements constrained optimisation in a two-stage process, where the first stage solves an optimisation problem that is similar to, but simpler than the planning problem, with the output of the first stage being used to initialise a second stage which is used to solve the full optimisation problem. This implementation of constrained optimisation includes two different types of constraints: hard constraints which relate to strict requirements such as a kinematic model and collision avoidance, and soft constraints, which relate to objectives such as progress towards a goal or comfort based on acceleration or steering.

### SUMMARY

One problem when planning trajectories for an AV or other mobile robot in real-world environments is that the view from the AV can be obscured by obstacles, creating regions of the environment that are occluded when trying to plan the AV's next action. Planning relies on perception outputs generated based on sensor measurements of a vehicle, such as camera images, radar and/or lidar measurements to determine where other agents or objects are present in the environment so as to avoid collision with other agents or objects while making progress towards a driving goal. When the environment is partially occluded, the AV cannot determine whether agents or other objects are present in the occluded region and cannot predict the future trajectories of any agents that are hidden from view at the time of planning.

One option is to treat occlusions as soft constraints in a constrained optimisation of a cost function having multiple terms defining soft constraints, with the occlusion cost term defined so as to encourage the AV to maintain a certain distance from the occluded region. However, this approach could lead to collisions if an obstacle in the occluded area is detected too late for the AV to react in time. Another option is to treat occlusions as hard constraints, by preventing the AV to enter an occluded region at all (rather than just discouraging it in the cost function). However, this can lead to over-conservative behaviours where an AV is stuck behind an obstacle and unable to make progress because it would require the AV to enter the occluded region.

An object of the present invention is to provide a planning method that encourages the AV to adjust its position so as to improve visibility (i.e. reduce occlusion) while also encouraging progress towards a goal.

A first aspect of the invention provides computer-implemented method of planning an ego trajectory for an ego robot in an environment in the presence of an occluding object, the method comprising: determining a trajectory cost function having one or more planning variables that define a planned ego trajectory, the planning variables tuneable to modify the planned ego trajectory, wherein the trajectory cost function is dependent on a predicted occluded region of the environment, as defined by the planned ego trajectory and a state of the occluding object; and
tuning the planning variables using an optimizer applied to the trajectory cost function, wherein the trajectory cost function encodes: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from the perspective of the ego robot, whereby the optimizer is incentivised to tune the planning variables in a manner satisfying the progress objective and the visibility objective.

A first aspect herein provides a computer-implemented method of planning an ego trajectory for an ego robot in an environment in the presence of an occluding object, the method comprising: determining a trajectory cost function having one or more planning variables that define a planned ego trajectory, the planning variables tuneable to modify the planned ego trajectory, wherein the trajectory cost function is dependent on a predicted occluded region of the environment, as defined by the planned ego trajectory and a predicted state of the occluding object; and tuning the planning variables using an optimizer applied to the trajectory cost function, wherein the trajectory cost function encodes: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from the perspective of the ego robot, whereby the optimizer is incentivised to tune the planning variables in a manner satisfying the progress objective and the visibility objective.

The optimiser may be a constrained optimiser that applies one or more hard constraints to the optimisation of the trajectory cost function, the hard constraints defining physical, safety, or comfort requirements for the ego robot's motion.

The hard constraints may comprise at least a constraint for the ego trajectory to avoid collision with an external agents and/or road boundaries.

The hard constraints may comprise a constraint that the planned ego trajectory avoids collision with a region defining the possible locations of static or dynamic objects that are hidden by the occluding object at a current timestep.

The trajectory cost function may further encode a collision avoidance objective that rewards modifications to the planned ego trajectory that avoid collision with a region defining possible locations of static and/or dynamic objects that are hidden by the occluding object at a current timestep, whereby the optimiser is incentivised to tune the planning variables in a manner satisfying the progress, visibility and collision avoidance objectives.

The trajectory cost function may further encode one or more safety and/or comfort objectives, whereby the optimiser is incentivised to tune the planning variables in a manner satisfying the progress, visibility, safety and comfort objectives.

The visibility objective may be based on a computed area of the predicted occluded region.

When implemented for planning an ego trajectory for an ego robot in an environment in the presence of multiple occluding objects, the trajectory cost function may be dependent on a predicted occluded region defined for each occluding object based on the planned ego trajectory and a predicted state of that occluding object.

The visibility objective may be based on a computed total area of the respective predicted occluded regions associated with each occluding object.

Any occluded region whose dimensions do not meet a predefined threshold for containing an occluded agent may be determined not to contribute to the computed total area of the predicted occluded regions.

The planned ego trajectory may be generated for a planning horizon of N future timesteps and comprise a sequence of N+1 ego states, each ego state corresponding to a respective timestep within the planning horizon.

The planning variables may comprise ego control variables for controlling the motion of the ego vehicle at each of the N future timesteps.

The ego control variables may control the acceleration and/or steering of the ego vehicle.

The occluding object may be a static object, wherein the predicted state of the occluding object is the state of the occluding object at a current timestep.

The occluding object may be a dynamic object, wherein the predicted state of the occluding object is determined using a prediction component of the ego robot, based on a state of the occluding object at a current timestep.

The method may comprise predicting a virtual agent occlusion region based on a currently occluded region, wherein the optimisation of the trajectory cost function is performed so as to avoid collision with the virtual agent occlusion region.

The optimisation of the trajectory cost function may be performed so as to avoid collision with the predicted virtual agent occlusion region by encoding in the cost function a collision objective that rewards modifications to the ego trajectory that avoid collision with the predicted virtual agent occlusion region.

The optimisation of the trajectory cost function may be performed so as to avoid collision with the predicted virtual agent occlusion region by applying a hard constraint for the ego trajectory to avoid collision with the predicted virtual agent occlusion region.

The predicted virtual agent occlusion region may be determined based on a virtual agent dynamics model defining a range of possible speeds of a virtual agent occupying the currently occluded region along a current path.

The method may comprise computing an initialisation trajectory, wherein the optimizer tunes the planning variables based on the initialisation trajectory.

The initialisation trajectory may be computed by a first-stage optimizer by optimising a simplified trajectory cost function that encodes a simplified planning problem.

The initialisation trajectory may be generated using a heuristic trajectory generation method.

The visibility objective may be encoded so as to reward modifications to the planned ego trajectory that improve visibility of the environment from the perspective of the ego robot only when a computed visibility metric is below a predefined visibility threshold.

A second aspect disclosed herein provides a computer system for planning an ego trajectory for an ego robot in an environment in the presence of an occluding object, the computer system comprising: an input configured to receive a predicted state of the occluding object; an optimiser configured to tune one or more planning variables defining a planned ego trajectory, by optimising a trajectory cost function which is dependent on a predicted occluded region of the environment, as defined by the planned ego trajectory and a predicted state of the occluding object, the trajectory cost function encoding: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from the perspective of the ego robot; wherein the optimiser is configured to tune the planning variables in a manner satisfying the progress objective and the visibility objective.

A further aspect disclosed herein provides a computer program comprising machine-readable instructions which, when executed on one or more computer processors, cause the processors to carry out any of the methods disclosed herein.

### BRIEF DESCRIPTION OF FIGURES

To assist understanding of the present invention, and to show how embodiments of the same may be carried into effect, reference is made by way of example only to the accompanying drawings, in which:

FIG. 1 shows a schematic block diagram of an autonomous vehicle stack;

FIG. 2 shows a simplified schematic block diagram of a method of planning in the presence of occlusions;

FIG. 3A shows an example scenario in which the planner uses soft constraints to avoid occlusions;

FIG. 3B shows an example scenario in which the planner uses hard constraints to avoid occlusions;

FIG. 4 shows an example scenario in which the planner uses a visibility cost term to increase visibility;

FIG. 5A and FIG. 5B shows how dynamic occluded agents are accounted for in planning;

FIG. 6 shows how occluded area varies for different positions of the ego vehicle;

FIG. 7 is a schematic block diagram showing the operation of the planner over multiple timesteps

FIG. 8 shows an example scenario using virtual agents to plan for occlusions.

FIG. 9A-9D show an example T-junction scenario using two agents.

### DETAILED DESCRIPTION

Safe motion planning under occlusions for autonomous vehicles remains an open challenge due to the complexity of the decision space under the uncertainty over the presence of occluded obstacles or the behaviour of an occluded agent that might interact with the self-driving vehicle (or ego in the following). Failure to properly handle occlusions can lead to collision due to the possibly quite limited reaction time to an obstacle becoming suddenly visible. Classical approaches to this problem generally focus on reasoning about the worst case scenarios; i.e. assuming the ego vehicle should plan taking into account ‘virtual’ agents always present in occluded areas. While these methods could guarantee passive/reactive safety, that comes at the expense of overconservative behaviours. In this context, active approaches that encourage ego's maneuvers to take exploratory actions to decrease the uncertainty over the the presence of occluded agents have been conceived to overcome this problem. In both the contexts of free space planning, for which the state space is continuous, or sampling-based methods, for which potential trajectories are generated and discriminated based on a planning score, it is non-trivial to devise a principled approach that would effectively embed this active exploration component into the planning algorithm.

Embodiments of a planning method for mobile robots in the presence of occlusions are described below. This method uses a cost function which is optimised to determine a planned ego trajectory, with the cost function rewarding progress towards a goal, but also rewarding exploration of the space that improves visibility in the presence of occlusions. In some embodiments, this optimisation is performed in the second stage of a two-stage constrained optimizer where the first stage solves a simplified version of the planning problem and uses its solution to initialise a second stage which finds an optimal solution to the full planning problem. Note that references herein to planning an ego trajectory may refer to computing planning variables that define an ego trajectory, which may, for example, include control variables that define the acceleration and/or steering of the ego robot. A given set of ego control variables can be mapped directly to a set of ego states, and vice versa. Some further details of this two-stage optimisation will be described below with reference to particular embodiments of the invention. This two-stage optimisation is also described in further detail in International Patent Publication No. WO2021/152050, which is incorporated herein by reference in its entirety.

The described embodiments formulate an active planning approach as a non-linear, non-convex optimisation problem, where uncertainty over the presence of occluded agents can be captured by a differentiable cost term. This term can be jointly optimised with other progress, safety and comfort cost terms. As described below, a two-stage optimisation framework is built upon a principled exploratory term in the optimisation cost function, the occlusion cost term, based on a differentiable function that maps ego's position to the size of the occluded areas given the scenario layout and static agents, is optimised together with other planning objectives.

The below embodiments relate to an example implementation of an autonomous vehicle (AV) planner. However, the described methods are equally applicable to other forms of mobile robot.

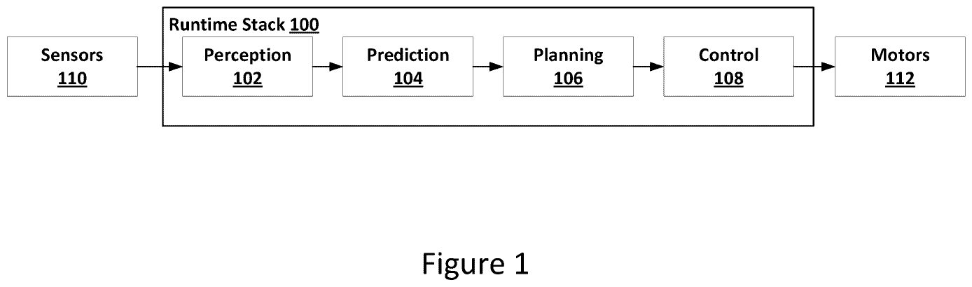

FIG. 1 shows a highly schematic block diagram of an autonomous vehicle (AV) runtime stack 100. The runtime stack 100 is shown to comprise a perception stack 102, a prediction stack 104, a planner 106 and a controller 108.

The perception stack 102 receives sensor outputs from an on-board sensor system 110 of the AV.

The on-board sensor system 110 can take different forms but generally comprises a variety of sensors such as image capture devices (cameras/optical sensors), LiDAR and/or RADAR unit(s), satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and any external actors (vehicles, pedestrians, cyclists etc.) within that environment.

Hence, the sensor outputs typically comprise sensor data of multiple sensor modalities such as stereo images from one or more stereo optical sensors, LiDAR, RADAR etc.

Stereo imaging may be used to collect dense depth data, with LiDAR/RADAR etc. proving potentially more accurate but less dense depth data. More generally, depth data collection from multiple sensor modalities may be combined in a way that respects their respective levels (e.g. using Bayesian or non-Bayesian processing or some other statistical process etc.). Multiple stereo pairs of optical sensors may be located around the vehicle e.g. to provide full 360° depth perception. This provides a much richer source of information than is used in conventional cruise control systems.

The perception stack 102 comprises multiple perception components which co-operate to interpret the sensor outputs and thereby provide perception outputs to the prediction stack 104.

The perception outputs from the perception stack 102 are used by the prediction stack 104 to predict future behaviour of the external actors.

Predictions computed by the prediction stack 104 are provided to the planner 106, which uses the predictions to make autonomous driving decisions to be executed by the AV in a way that takes into account the predicted behaviour of the external actors.

The planner 106 implements the techniques described below to plan trajectories for the AV and determine control actions for realizing such trajectories. In particular, a core function of the planner 106 is to determine a series of control actions for controlling the AV to implement a desired goal in a given scenario. In a real-time planning context, a scenario is determined using the perception stack 102 but can also incorporate predictions about other actors generated by the prediction stack 104. A scenario is represented as a set of scenario description parameters used by the planner 106. A typical scenario would define a drivable area and would also capture predicted movements of any obstacles within the drivable area (such as other vehicles) along with a goal. A goal would be defined within the scenario, and a trajectory would then need to be planned for that goal within that scenario. In the following, obstacles are represented probabilistically in a way that reflects the level of uncertainty in their perception within the perception stack 102.

For example, the goal could be to enter a roundabout and leave it at a desired exit; to overtake a vehicle in front; or to stay in a current lane at a target speed (lane following). The goal may, for example, be determined by an autonomous route planner (not shown). A default goal may be to follow a drivable path of the AV as determined by a route planner. Progress towards the goal would in this case be measured as progress along the drivable path.

The controller 108 executes the decisions taken by the planner 106 by providing suitable control signals to on-board actuators 112 such as motors of the AV. In particular, the controller 108 controls the actuators in order to control the autonomous vehicle to follow a trajectory computed by the planner 106.

The planner 106 plans over acceleration (magnitude) and steering angle control actions simultaneously, which are mapped to a corresponding trajectory by modelling the response of the vehicle to those control actions. This allows constraints to be imposed both on the control actions (such as limiting acceleration and steering angle) and the trajectory (such as collision-avoidance constraints), and ensures that the final trajectories produced are dynamically realisable. The planner 106 will determine an optimal trajectory and a corresponding sequence of control actions that would result in the optimal trajectory according to whatever vehicle dynamics model is being applied. The control actions determined by the planner 106 will not necessarily be in a form that can be applied directly by the controller 108 (they may or may not be). Ultimately, the role of the planner 106 is to plan a trajectory and the role of the controller 108 is to implement that trajectory. The term “control data” is used herein to mean any trajectory information derived from one of both of the planned trajectory and the corresponding series of control actions that can be used by the controller 108 to realize the planner's chosen trajectory. For example, the controller 108 may take the trajectory computed by the planner 106 and determine its own control strategy for realizing that trajectory, rather than operating on the planner's determined control actions directly (in that event, the controller's control strategy will generally mirror the control actions determined by the planner, but need not do so exactly).

The planner 106 will continue to update the planned trajectory as a scenario develops. Hence, a trajectory determined at any time may never be realized in full, because it will have been updated before then to account for changes in the scenario that were not predicted perfectly.

These functions of an example planner 106 that accounts for planning in the presence of occluded regions within the drivable region will now be described in further detail. As mentioned above, the example planner described treats the determination of an optimal series of control actions (referred to herein as a “policy”) for a given scenario and a given goal as a constrained optimization problem with two optimization stages. However, the described method of dealing with occlusions is not limited to any single implementation of a constrained optimisation technique in the planner, and could instead be used in a single optimisation encoding various requirements or desired outcomes relating to safety, progress towards a goal, and comfort.

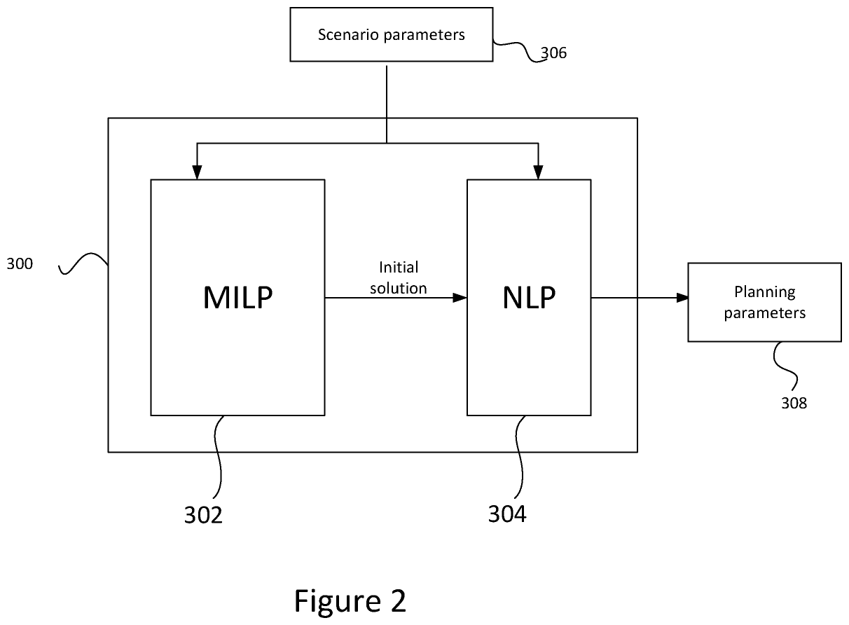

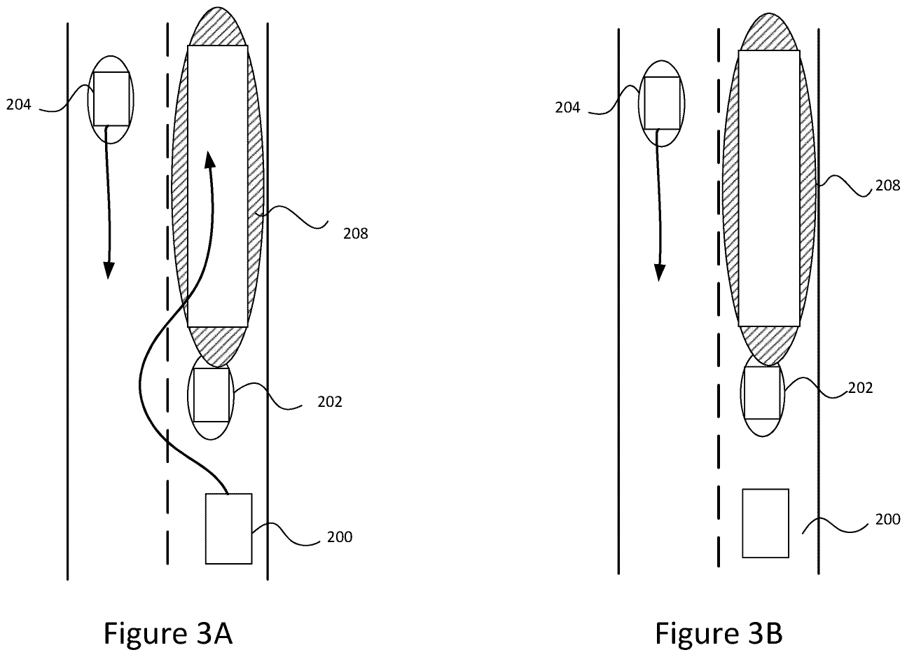

For context, some more details are first provided on the example two-stage constrained optimisation based planner, with reference to FIG. 2. The problem of occlusions in planning and a description of how this planner can be used to deal with occlusions is laid out in further detail with reference to FIGS. 3-7. As mentioned above, constrained optimisation aims to find an optimal solution that satisfies a number of constraints. In this case, these constraints encode requirements for the ego trajectory, for example to avoid collision with other agents and be physically feasible, among other required or desired levels of safety, comfort or progress towards a goal.

FIG. 2 shows a block diagram of a two-stage constrained optimisation based planner. The two-stage optimisation architecture includes a first stage 302 which corresponds to solving a linearized version of the optimisation problem, while the second stage 304 solves the problem in a non-linear non-convex constrained optimisation fashion using the solution of the first stage as an initialisation. In the present example, the first stage uses mixed-integer linear programming (MILP) to solve a linearised version of the optimisation problem. The linearised version of the optimisation problem defines a cost function which is less complex than the cost function for the full optimisation problem, but still includes some of the most important objectives in planning such as collision avoidance. This simplified cost function is optimised to determine an initial solution to this simpler version of the optimisation problem.

The initial solution is then provided to the second stage of the constrained optimisation architecture 304, which uses non-linear programming (NLP) to solve the full optimisation problem by optimising a second cost function to find a set of planning parameters defining an ego trajectory to best satisfy a full set of constraints.

Both stages of the optimisation receive scenario parameters as inputs based on which an ego trajectory can be planned, the scenario parameters including an initial state of the ego vehicle (e.g. position, orientation and motion) as well as a set of states for other agents of the scenario (and a set of covariances representing the uncertainty associated with these predicted states) over future timesteps from the point in time from which the trajectory is planned.

The constrained optimisation problem solved by the example two-stage optimiser of FIG. 2 can be formalised as follows. Given a state z of a driving scenario, the state including vehicle states for the ego and other agents of the scenario, positional uncertainties, layout information [symbol] and predictions of other agents over a fixed horizon, the goal of the planner is to obtain a plan for the ego agent as a sequence of N+1 ego states over the planning horizon

$${τ}^{*} = {τ}_{0 : N}^{ego} ,$$

so as to minimise a cost function [symbol] (t):

$${τ}^{*} = arg {min}_{τ} 𝒥 ( τ )$$

subject to constraints: τ₀=z_{ego}, gₕ_{_{ineq}}(τ_{0:N})≤0, gₕ_{_{eq}}(τ_{0:N})=0, where z_{ego} refers to the initial ego state, and gₕ_{_{ineq}} and gₕ_{_{eq}} are sets of general inequality and equality constraints, respectively, parameterised by the input scene on the ego-vehicle states.

The above description and FIG. 2 provide a simplified summary of a two-stage technique for planning an ego trajectory subject to multiple constraints. A more complete mathematical description is provided in International Publication No. WO2021/152050. As described in the earlier application, a non-linear transformation is applied to project the global reference frame [symbol] into a Frenet reference frame [symbol] _{ref} along a reference path [symbol] _{ref} determined by a route planner. This produces the internal representation of the states within the optimisation framework. An inverse transform [symbol] ⁻¹ is applied to the planner output to express the resulting plan in [symbol] . Ω [symbol] ⊂R² is the reachable set of ego states in the planning horizon following the reference path [symbol] _{ref} augmented by the reachable set of all hypothetical agents that could interact with the ego (i.e. reach its reachable set) within the planning horizon under the road rules (speed limits, lane directions, etc.). That is, Ω [symbol] represents the important part of the driving surface [symbol] according to the ego's mission.

Each of the first and second stages of the two-stage optimisation perform optimisations that incorporate constraints on the ego trajectory based on various considerations for the driving scenario. A primary consideration, as mentioned above, is the requirement to avoid collision with other agents of the scenario, and both the MILP and NLP optimisations are performed subject to a constraint ensuring that the ego vehicle never collides with an external agent along its planned trajectory. A distinction is made in the present example between ‘hard’ constraints such as collision avoidance, or speed limits, which must be met for the planned ego trajectory to be safe, and ‘soft’ constraints, which encode objectives of the optimisation, such as acceleration and steering being within ranges deemed comfortable for humans, and progress towards a goal. Hard constraints are formulated as inequality constraints of the form g_{z}(τ_{0:N})≤0 and equality constraints of the form h_{z}(τ_{0:N})=0. Soft constraints are incorporated as terms in the cost function for both MILP and NLP stages of the optimisations (though the terms themselves may differ between the two stages), with the cost function optimised so as to satisfy these constraints as far as possible, but not strictly enforcing them. The hard constraints are implemented by optimising the cost function subject to those constraints being satisfied. Different hard constraints may be implemented for the first and second stages. Any possible solution from either stage of the optimisation necessarily satisfies the hard constraints defined for that stage of the optimisation.

Collision risk is calculated based on the predicted states of agents that the ego vehicle is aware of at t=0, for example having identified other agents of the driving scenario using detectors of the vehicle's perception system 102. However, an issue arises when regions of the drivable area are obscured by obstacles, such as other agents, such that an external agent that could be in that region is not perceived by the ego vehicle, even though an agent in the occluded region could interact with the ego vehicle within the planning horizon, making it difficult to determine whether a trajectory that enters that region is likely to collide with another agent.

FIG. 3A shows an example method where an ego vehicle 200 is approaching a static agent 202 which obscures the region immediately in front of the static agent. In this example, the occluded region is treated as a region to be avoided only as a soft constraint. In this formulation, occluded areas are considered potentially occupied, but represented by soft collision constraints, rather than avoiding the entire region in which an agent could be present as a hard constraint. For the static agent 202, as well as a second moving agent 204 approaching in the opposite lane, an ellipse around the boundaries of the agent is used to compute the hard constraints for collision avoidance, where the dimensions of the ellipse around a given agent are based on the dimensions of the agent itself, such that the ellipse provides a conservative area around the agent 204 to be avoided by the ego vehicle 200 in order to avoid collision. Similarly, an ellipse 208 can be defined around a polygonal occluded region in front of the static agent 202 (or behind the static agent from the point of view of the ego agent 200). The occluded area of the given driving lane is determined based on a visibility model that takes into account the distance from the ego to the obstacle and with what angle the ego is approaching an obstacle in order to determine a length of the given lane that is occluded, and an ellipse that has that length is created over the lane. The extent of the ellipse is based on the region of road in which another static agent, or any other type of obstacle with which it is possible for the ego vehicle 200 to collide, may be present. The dimensions of the ellipse are such that it covers the region in which any possible hidden objects, i.e. other static agents or other possible obstacles that can't be seen due to the occlusion by the agent 202, may be positioned. The occluded region is treated as static throughout the planning horizon. In other words, it is assumed in this example that any hidden agents or other objects in the occluded region are not moving.

In the example of FIG. 3A, avoidance of the occluded region is treated as a soft constraint by including a term in the cost function to penalise ego trajectories that cross or overlap with the ellipse 208. The planner then plans a trajectory that avoids the ellipse 208 to the degree possible while satisfying hard constraints to avoid collision with the agents 204 and 202, among other hard constraints such as complying with road rules, etc. This enables the planner to determine a trajectory that makes progress towards the ego's goal. An example of such a trajectory is shown by the line extending from the ego vehicle and overtaking the static vehicle. This trajectory enters the ellipse 208 defined by the occluded region at the point from which the trajectory is planned, which would be penalised by the soft constraint, but the trajectory satisfies the hard constraint not to collide with the existing agents 202 and 204 (based on the agent 204 following a predicted trajectory) and progresses towards a goal of continuing in the existing lane.

However, a possible issue with planned trajectories that overlap with the occlusion ellipse 208 is that an agent might be present in the occluded region, with this only becoming known to the ego vehicle at some later point in time, in which the ego may have followed an initial part of the planned trajectory. If this occurs in the scenario in FIG. 3A when the ego has already begun an overtake maneuver, for example where a second static agent is parked behind the first static agent 202, the ego must plan an updated trajectory at a later timestep, and the path in the left hand lane would need to be extended in order to overtake both vehicles. However, where the original trajectory may have been planned based on the overtake maneuver being complete by the time the oncoming agent 204 passes the static vehicle, avoiding any possible collision, once it is clear that a second agent is present behind the first agent 202 and the portion of the trajectory in the left lane is extended, there is a risk of collision with the agent 204, or requiring either or both of the ego vehicle 200 and the agent 204 to brake suddenly to avoid collision. While treating avoidance of the occlusion ellipse as a soft constraint allows the planner to find trajectories that progress towards a planning goal from a given starting point where that ellipse represents possible hidden objects, the possible updates to the planned trajectory over time as the driving scenario progresses can lead to unsafe situations, for example causing the ego and/or external agents to take emergency action to avoid collision.

An alternative approach is shown in FIG. 3B. This figure shows the same driving scenario, where the ego vehicle 200 is approaching a static obstacle 202 in the right lane, behind which is an occluded region which is not within the field of view of the ego vehicle's sensor system (e.g. cameras, etc.). An occlusion ellipse 208 can again be defined based on the visibility model which determines an occluded region based on the relative position of the ego vehicle 200 and the static agent 202 and defines an ellipse around the corresponding length of road lane. FIG. 3B shows a more conservative approach in which avoidance of the occlusion ellipse 208 is treated as a hard constraint. In other words, the optimisation is performed subject to the constraint that the trajectory does not collide with any of the ellipses defined for the agents 202, 204, or the ellipse 208 defined based on the occluded region, essentially treating the occluded region as a large static agent in the scene.

In the scenario shown, this does not enable the ego vehicle to plan any trajectories that progress towards a goal of continuing in the right lane, since this would require the ego to continue in the left lane for the length of the occluded region, which is not safe due to the oncoming agent 204. In order to plan a trajectory that overtakes the static agent 202, the ego would have to wait until it is confident that the left lane is clear for long enough to allow the ego to pass the entire occlusion ellipse.

As mentioned above, each planned trajectory determined by the planner is only partially executed, since the ego then generates a new planned trajectory from its future state. If the ego 200 started to move left and more of the occluded region became visible by the ego's sensor system, it could turn out that no agent is present in the occlusion ellipse, and then a safe trajectory towards the goal of continuing in the right lane could be planned from that point, since the occluded region to be avoided is no longer present (or is reduced in size). However, the problem in treating the occlusion ellipse as a hard constraint while optimising the cost function so as to find a trajectory that makes progress towards a goal is that if no trajectory can be found that makes progress towards that goal from the initial state of the ego vehicle, then no suitable trajectories are planned and the ego remains ‘stuck’ behind the static occluding agent 202 until it can determine a trajectory where the entire occluded region can be avoided, even if no agents are present in the occluded region at all.

A distinction is made between the occluded region caused by the presence of an obstacle relative to the ego vehicle at a given time, and the occlusion ellipse defined for the purpose of planning a trajectory to avoid collision with potential obstacles. The occluded region is a polygonal region of a respective lane which is determined as occluded based on a visibility model, as described in more detail below. The occlusion ellipses used for collision avoidance are defined based on the occluded region. In the present example, the ellipses are defined as the ellipse having the same length as the occluded region and including the full lane width, although other collision regions could be defined as necessary for the given planning application.

As described in further detail below, when planning a trajectory, the planner considers both a current state of the ego vehicle 200 and the state of the other agent, at the (current) timestep from which the trajectory is planned, as well as a set of future states based on predictions. These future states may never occur in real life, since the agents could behave differently to how they are predicted to behave, but these are used to plan a future set of actions of the ego vehicle at the current timestep.

A ‘candidate’ ego trajectory can be evaluated in planning based on how the ego satisfies constraints or objectives such as progress towards a goal, based on the predicted behaviour of the other agents of the scene. At some later timestep along that candidate trajectory, the ego state is updated, and the region that is predicted to be occluded at that timestep will have changed from the occluded region at the start of the trajectory based on the predicted/planned relative position of the ego vehicle and occluding agent 202. This change could make it easier for the planner to generate a new trajectory from that future point based on the observed presence or absence of agents in the region that is currently (i.e. at time t=0) hidden. However, at the time of planning that trajectory, there is no way to know whether that region does or doesn't contain other agents, and so the occlusion ellipse for that timestep of the planned trajectory remains the same, since the planned trajectory should avoid collision based on what is possible at the time of planning. Occluded regions are dependent only on the relative positions of the ego sensors and any occluding agents, while the occlusion ellipses are defined based on the region that is occluded at the current timestep, and do not change during the planning horizon based on predictions for the other agents of the scene or the planned trajectory of the ego vehicle. As a real-life scenario progresses in time, the planning process is repeated, and a new occlusion ellipse is determined based on the occluded region at the given point in ‘real’ time, where the occlusion ellipse is static over the planning horizon. Note that this discussion relates to occlusion ellipses defined to plan for the possibility of static agents being present in occluded regions, meaning that the planned trajectory assumes that the occluded region is essentially one static obstacle over a planning horizon of N timesteps for which the planned trajectory is computed. Dynamic occluded agents are discussed in more detail below.

An improved method of dealing with occlusions adds a further objective to the cost function of increasing visibility (i.e. decreasing the area of the occluded region over the course of the ego trajectory) in addition to progressing towards the planning goal (for example continuing in the right lane). This is done by adding a visibility term to the cost function of the optimisation described above, with this visibility term being dependent on the area of the occluded region, so as to jointly reward improvements to visibility as well as progress towards the planning goal.

Referring again to the scenario of FIG. 3A/3B, by rewarding ego trajectories that decrease the size of the occluded region as well as those that make progress towards a driving goal, while still treating avoidance of the occlusion ellipse as a hard constraint, the planner can plan an initial trajectory that moves the ego towards the left lane, sufficient to make some of the occluded region visible. This reduces the size of the occluded region at the next planning step, and may enable a trajectory to be planned from a future timestep which can execute an overtake maneuver on the static occluding vehicle 202 and continue in the right lane according to the planning goal. On the other hand, if the ego 200 determines that a second agent is present in the formerly occluded region, so an overtake cannot safely be performed, the ego can safely return to the right lane to wait for the oncoming vehicle to pass. In either case, the trajectories planned from the current timestep are planned so as to avoid collision with the occlusion ellipse and therefore ensure that the ego does not collide with any hidden agents while following that trajectory.

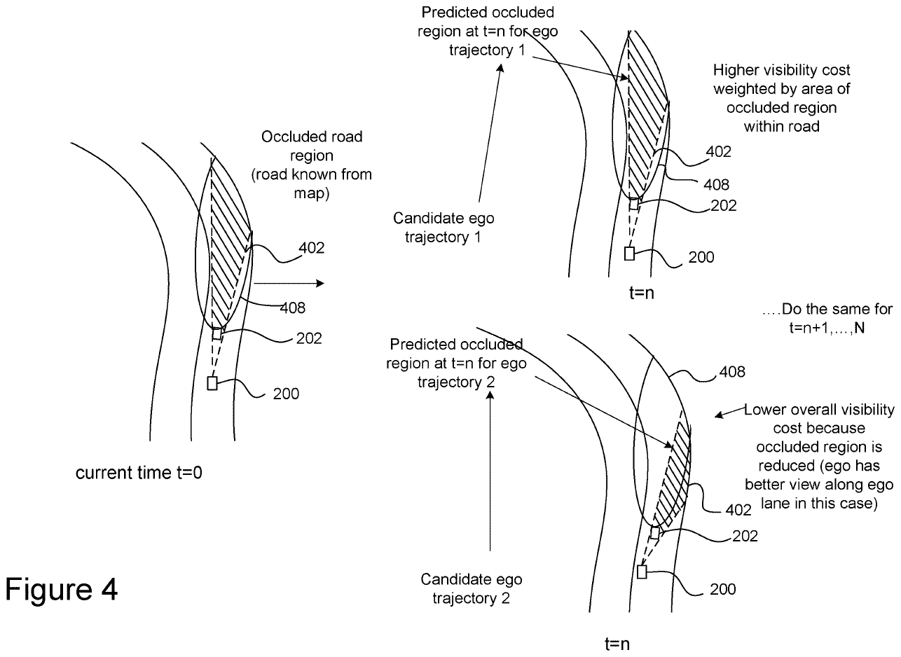

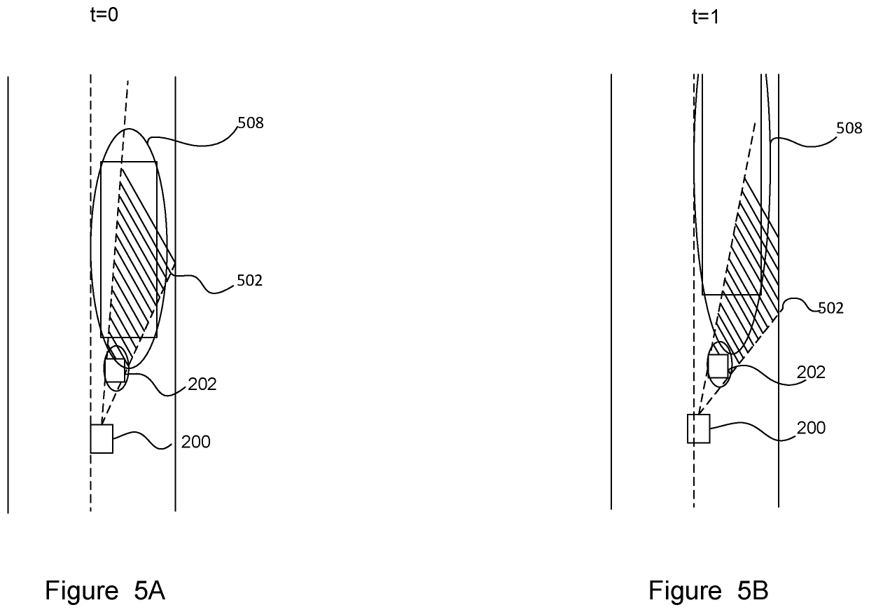

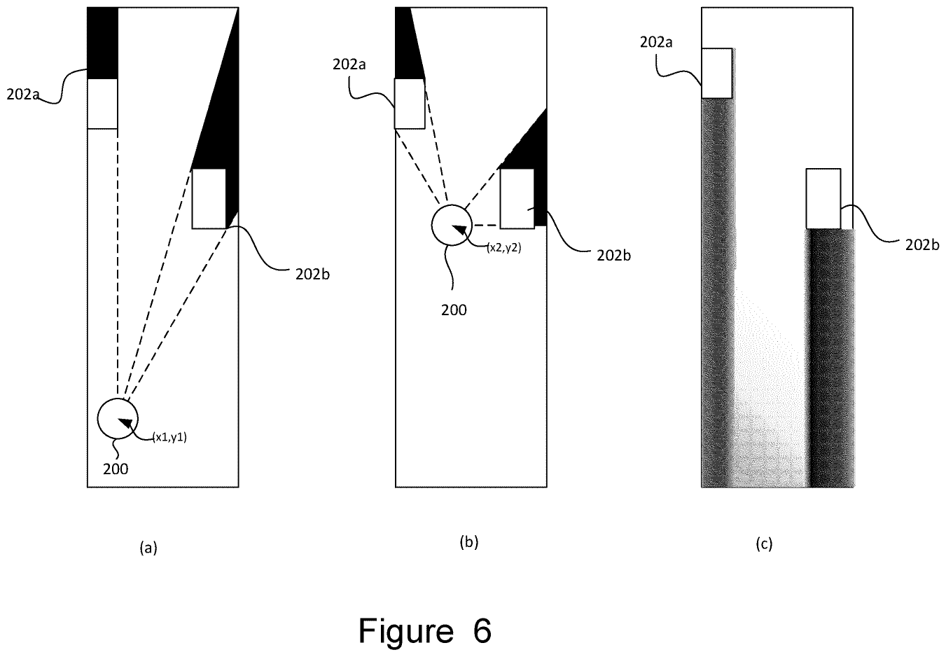

FIG. 4 shows how this improved method can be used to improve visibility as a way to safely plan in the presence of occlusions, while still making progress towards driving goals. A driving scenario is shown at an initial timestep t=0, where the ego vehicle 200 is shown driving along the right lane approaching a static occluding vehicle 202. At this initial state, the occluded region of the road can be determined using a road map by projecting from the position of the ego's sensors, e.g. a camera mounted on the ego vehicle, along the outer corners of the occluding agent 202 to the road limits, defining an occluded region 402. This process is described in further detail below with reference to FIG. 6. It should also be noted that only the ‘useful’ part of the road layout is considered when computing the occluded region, where the useful part includes only the lanes for which agents travelling in the lane could affect the ego's plan within the given planning horizon. It should also be noted that FIG. 4 shows a representation of a scenario in a ‘real-world’ reference frame for illustration purposes only, and in practice these techniques are applied in the reference-path frame of reference and the planner outputs transformed back to the real-world frame of reference. While shown as ellipses or partial ellipses in FIG. 4, the occlusion ellipses formed in the path-based reference frame may map to other shapes in the real-world reference frame. FIGS. 5A and 5B illustrate the application of the same method in the transformed path-based reference frame.

At the initial state, t=0, the occluded region 402 extends across the ego lane, blocking the ego's view of the ego lane immediately ahead of the static agent 202. An occlusion ellipse 408 can also be defined in this region based on the possible locations of other static agents within the occluded region. Since, in the present example, avoiding the occlusion ellipse is a hard constraint, no trajectory planned from this initial timestep would be able to enter into this ellipse, and therefore any overtake of the static region would require the ego vehicle to drive along the left lane (i.e. the oncoming lane) for an extended period.

If the technique of FIG. 3B were used in this scenario, where the trajectory is selected to maximise progress subject to the hard constraints such as collision with other agents or the occlusion ellipse, then this could lead to a lack of progress in the case that agents are present in the oncoming lane, since the ego vehicle cannot plan any safe trajectory that avoids both the oncoming agents and the occlusion ellipse 408.

However, according to the improved planning method, the trajectory is planned so as to optimise both progress and visibility, with visibility being defined based on the area of the occluded region 402 caused by the relative position of the ego vehicle relative to the occluding agent 202. This allows the ego to plan a trajectory that improves visibility, even if it does not make progress towards a driving goal, which could allow the ego to plan a full trajectory that progresses towards that driving goal, at a later timestep in the scenario when visibility is better and the ego vehicle can be more certain of the presence or absence of agents in the ego lane.

Shown on the right of FIG. 4 are two versions of the same driving scenario at a later timestep t=n. Each of these versions of the scenario are associated with a different ‘candidate’ trajectory, where the state of the ego vehicle in each case corresponds to the position and motion of the ego vehicle at the later timestep t=n according to the respective candidate trajectory. Note that the determination of an optimal trajectory, for example using the two-stage optimisation technique described above, does not necessarily involve any direct comparison of such ‘candidate’ trajectories, these are merely shown in FIG. 4 to illustrate how different ego positions affect the area of the predicted occluded region and therefore the cost function for the given trajectory.

For the first candidate trajectory, shown in the top right of FIG. 4, the ego vehicle has moved forward along its current lane, but maintaining some distance from the centre line of the road. As shown by the occluded region 402, this updated ego position still results in a relatively large occluded region. It should be noted that, while regions outside of the road boundaries may also be occluded by the agent 202, only occluded areas of the drivable region, within the road boundaries, contribute to the visibility term of the cost function. The area of this region is computed as part of the visibility term, leading to a relatively high contribution to the cost function from the visibility term. The occluded region is predicted based on the predicted position of the agent 202 at the timestep t=n, and the position of the ego 200 at the timestep t=n based on following the first candidate trajectory. In this case, since the agent 202 is static, its predicted position at future timesteps remains constant over the planning horizon.

When considering future timesteps within a planning horizon from a current timestep t=0, in order to compare or evaluate the ego trajectory, there is no way to ascertain whether any static agents are present in the region that is occluded at t=0. In this example implementation, the occlusion ellipse 408 remains static for the entire planning horizon, and when planning from the timestep t=0, a worst-case assumption is made that the occlusion ellipse 408 should be entirely avoided as a hard constraint, and there is no way to confirm from the current timestep of t=0 whether this occlusion ellipse does include any further obstacles. However, in other implementations, the visibility term of the cost function could also be used along with a soft constraint on collision with the occlusion ellipse, so as to encourage the ego vehicle to increase visibility while discouraging (but not strictly prohibiting) the ego vehicle from planning a trajectory that interacts with the occlusion ellipse.

For the second candidate trajectory, shown in the bottom right of FIG. 4, the ego vehicle moves forward and left by timestep t=n according to the planned trajectory, moving slightly more towards the centre line of the road. This provides greater visibility of the right lane in front of the static agent 202, and results in a predicted occluded region 402 having a smaller overall area than that of the first candidate trajectory at the same timestep. The contribution to the cost function from the visibility term is therefore lower and the overall cost of the trajectory is lower, assuming that other objectives relating to progress and other factors such as comfortable acceleration and steering are similar for both trajectories. It should be noted that the cost function terms are weighted based on a relative importance attributed to the various objectives, where these weights can be fine-tuned to achieve a desired performance.

As mentioned above, the occlusion ellipse is static for the updated timestep t=n, since at the time of generating the planned trajectory, there is no way to predict what is in the currently occluded region associated with the occlusion ellipse 408, even if the planned trajectory predicts that the ego vehicle will be able to see that region at t=n. However, if this trajectory is followed in an actual driving scenario (real-world or simulated), it may allow the ego to plan a more optimal trajectory from its updated state at t=n, since the visibility has improved significantly, and the occlusion ellipse generated at that stage may be much smaller. The occlusion ellipse remains static only based on the assumption in the present example that any hidden obstacles are static.

FIGS. 5A and 5B show how the same method of planning in the presence of occlusions can be applied in the case where it is assumed that dynamic agents could be present in the occluded region at the time of planning the ego trajectory (i.e. at t=0). The scenario is shown in the path frame of reference, i.e. relative to a reference path determined for the ego vehicle using a route planner. This is shown as a straight section of road in the case of a reference path that lies along the centre line of the lane in which the ego lane is driving.

FIG. 5A shows a scenario in which the ego vehicle 200 approaches a static agent 202 at a current timestep t=0. At the current position of the ego vehicle, the agent 202 occludes a region of the road in front of the agent 202 such that the part of the ego lane in front of the agent 202 is blocked from the ego's view, creating an occluded region 502. Within this occluded region, there could be a dynamic agent, or multiple dynamic agents, which at the current timestep t=0 are hidden from the ego's view. Their current possible positions are used to define an occlusion ellipse 508, which defines the region that the ego trajectory needs to avoid at the current timestep. This ellipse may be referred to as an occlusion ellipse. As described above with reference to FIG. 3B, the occlusion ellipse is treated as another agent of the scene spanning the length of the occluded region. However, in the example of FIGS. 5A and 5B, the assumption that all occluded objects are static is no longer applied.

The occluded area is modelled as a dynamic ‘virtual’ or ‘ghost’ agent represented by a varying occlusion ellipse which moves along its current lane in the direction of travel, with the ellipse expanding over time based on the motion of the virtual agent based on a virtual agent dynamics model. These regions representing areas in which real agents may exist may be referred to herein as both virtual agents and virtual agent collision regions. For the purposes of prediction and planning, the region is treated as one large agent. For one example dynamics model, the virtual agent expands along its current direction of travel to account for a predefined range of possible speeds of an agent within the occluded region, with the back of the ellipse (relative to the direction of travel) representing the position of the virtual agent assuming it travels at a minimum speed of the predefined speed range, and the front of the ellipse (relative to the direction of travel) representing the position of the virtual agent assuming that it travels at a maximum speed of the predefined speed range. Other virtual agent dynamics models may be considered which take into account road rules, physical constraints on the motion of vehicles or other agents, and/or other assumptions about agent behaviour as appropriate for the given environment.

When the road layout forks into multiple possible lanes along the path of the virtual agent, for example at an intersection, the virtual agent ‘splits’ into multiple virtual agents, one for each possible direction available at the intersection. The occlusion ellipse can be seen as the union of the reachable sets of all possible agents starting from all possible positions within the occluded region at t=0, and travelling at all possible speeds within the occluded region. As described above with reference to FIGS. 3A and 3B, the occlusion ellipses can be treated as either hard or soft collision constraints in the optimisation.

FIG. 5B shows a predicted update of the scenario at a later timestep t=n which may be considered by the planner, where the ego vehicle has moved along a candidate trajectory, now being positioned more towards the centre line of the road, providing greater visibility of the ego lane beyond the agent 202. The visibility cost term for this candidate trajectory would therefore be low, at least up to the timestep t=n, since the occluded region has decreased in area. However, the occlusion ellipse 508 at this later timestep is also updated in this case, since the potential dynamic agents that are currently hidden (i.e. cannot be observed by the ego at t=0) could now be positioned further along the road, depending on how fast they are moving. As a result, the virtual agent represented by the occlusion ellipse 508 is increased in size to account for hidden agents and ensure that any ego trajectories planned from the current time t=0 do not collide with the occlusion ellipse, i.e. the region in which currently hidden agents could be positioned over the course of the planning horizon.

The occlusion ellipse 508 shown in FIG. 5B is elongated over time to extend further along the road. As mentioned above, the extent of the ellipse is based on an assumption about the speed of the hidden agents, by increasing the size of the virtual agent to include both hidden agents travelling at the maximum speed of a predetermined allowable range of speeds for that road, and hidden agents travelling at the minimum allowable speed of the predetermined speed range. This allows the planner to plan (partial) trajectories that improve the visibility of the road such that at a later timestep in the scenario, once the ego has followed the planned trajectory for a time period, the static and/or dynamic agents in the scene can be observed by the ego 200. When planning from that later timestep, the occlusion ellipse is reduced due to the improved visibility and a trajectory that progresses towards the driving goal can be planned.

The conservatism of the planner handling the virtual agents as represented by the variable occlusion ellipse 508 depends on the chosen range of speeds for the virtual agent. A safe, but conservative choice, is to set the minimum speed to 0 and the maximum speed to the road speed limit. However, this may be an overly-conservative assumption as it does not take into account that the visibility of the ego changes as it approaches the virtual agent, nor that the planner might have additional chances to respond to potential threats that could appear in the future. In other words, by making a worst case assumption that the virtual agent could have a minimum speed of 0, this constrains the planner to highly conservative trajectories within the planning horizon in order to avoid collision with the virtual agent, even if the ego vehicle has ample time to follow a collision trajectory for a small period of time, and at a later time in the real-world scenario, once visibility has improved and the occluded region has reduced in size, plan a safe trajectory that avoids collision with any visible agents. A more practical alternative is to set the minimum speed to 0 only when the ego vehicle 200, travelling along the reference path, has a time-to-collision with the moving virtual agent area lesser than the time that will require the ego vehicle to complete an emergency brake manoeuvre to avoid collision with that virtual agent from the future position where the closest point of the occluded virtual agent becomes visible. Otherwise, with the knowledge that a contingency plan exists, the minimum speed could be set to some optimistic estimate, e.g. to the speed limit.

The above model of agent speed is based on an assumption that any hidden agents are vehicles which are driving within the driveable region. However, the same techniques can be extended to other types of agents such as pedestrians, bicycles, etc. Different rules and motion constraints may be defined for different types of agents, and specific rules may need to be enforced as constraints during planning in order to handle different types of agents, including vulnerable road users, for example.

Some mathematical details of the example constrained optimisation described above will now be provided for additional context. As mentioned above, this example implementation uses a two-stage optimiser, with the first stage providing an initialisation to the second stage, which solves a non-linear optimisation problem subject to a set of hard constraints. In this example, the secondary objective of increasing visibility is implemented in the second stage of the optimisation. Mathematically, the non-linear optimisation stage aims at minimising an objective function [symbol] (t) subject to a set of equality and inequality constraints gₕ(τ), (where these equality and inequality constraints are hard constraints which must not be violated:

$${arg min}_{τ} 𝒥 ( τ , P )$$

$$s . t . \qquad {g}_{{h}_{i n e q}} ( τ , P ) \leq 0 ∀ {h}_{i n e q} , \qquad {g}_{{h}_{i n e q}} ( τ , P ) = 0 ∀ {h}_{e q} ,$$

where the objective function is the sum of soft constraints, while the inequality constraints are hard constraints not to be violated.

The state τ is a vector of states comprising position, speed and yaw angle, and is computed for each timestep over a horizon of N timesteps. The optimisation may be formulated to generate a set of ego controls [a, β]ₜ (acceleration and steering angle, respectively) which can be mapped directly to an ego trajectory (i.e. time sequence of ego states) by modelling the ego vehicle's response to the control actions. P denotes the set of parameters (including weights applied to the soft constraints within the cost function) that are part of the optimiser configuration.

The cost function [symbol] (X, P) is a sum of cost terms encoding soft constraints of the optimisation problem. A key objective of the optimisation is to control the vehicle to make progress towards a planning goal. Therefore one term of the cost function is a goal term, which rewards ego states that progress the ego towards that goal. The goal term may, for example, be defined as follows:

$${f}_{g o a l} = {w}_{G} \cdot \frac{{( {x}_{N} - {x}_{G} )}^{2}}{{x}_{G}^{2}} ,$$

where x_{N} is the position of the ego vehicle along a reference path at timestep N according to the planned trajectory, x_{G} is the position of the goal along the reference path, and w_{G} is a weight that determines the importance attributed to the goal cost term. The reference path is described in more detail in International Patent Publication No. WO2021/152050. This term is higher for ego trajectories that end far from the target position, such that minimising this term encourages the ego trajectory to end close to the final position associated with the planning goal.

Various other terms may be included in the cost function, for example to reward comfortable steering and acceleration and to encourage the ego to move at a target speed.

A visibility cost term is defined as a function of the position of the ego (x, y) as follows:

$${f}_{o c c} ( x , y ) = {w}_{o} exp \frac{{𝒪}_{𝒫} ( x , y ) - \underline{o}}{\overline{o} - \underline{o}} ,$$

where [symbol] (x, y) is an occlusion map evaluating the occluded area for each position of the ego vehicle within the reachable driving area for the given planning horizon,

$$\overline{o} = {max}_{x , y} {𝒪}_{𝒫} ( x , y ) and \underline{o} = {max}_{x , y} {𝒪}_{P} ( x , y )$$

are the maximum and minimum areas of the occlusion map respectively, to normalise the cost function ƒ_{occ} within its range, and wₒ is the weight assigned to the occlusion cost term within the overall cost function [symbol] . Further details of how this map is computed are provided below with reference to FIG. 6.

The cost function [symbol] is then optimised subject to the hard constraints, which consist of both equality and inequality constraints. These could include, for example, a kinematic constraint defined as follows:

$$[ {x}_{i + 1} {y}_{i + 1} {θ}_{i + 1} {v}_{i + 1} ] = [ {x}_{i} {y}_{i} {θ}_{i} {v}_{i} ] + [ {v}_{i} cos ( {θ}_{i} + {β}_{i} ) {v}_{i} sin ( {θ}_{i} + {β}_{i} ) \frac{2 {v}_{i}}{L} sin ( {β}_{i} ) {a}_{i} ] \cdot Δ t ,$$

which defines the motion of the ego vehicle from one timestep to the next based on the steering and acceleration parameters, using physical laws of motion. This is an equality constraint, and can be written as follows:

$${g}_{k i n} ( X , P ) = [ {x}_{i + 1} {y}_{i + 1} {θ}_{i + 1} {v}_{i + 1} ] - ( [ {x}_{i} {y}_{i} {θ}_{i} {v}_{i} ] + [ {v}_{i} cos ( {θ}_{i} + {β}_{i} ) {v}_{i} sin ( {θ}_{i} + {β}_{i} ) \frac{2 {v}_{i}}{L} sin ( {β}_{i} ) {a}_{i} ] \cdot Δ t ) .$$

Another possible hard constraint that may be applied is a speed constraint that ensures that the speed of the ego vehicle is always less than a predefined maximum speed (which may be the legal speed limit for the relevant section of road), as well as ensuring the speed of the ego vehicle does not have negative values:

$${v}_{i} \leq {v}_{max} ∀ i ,$$

$$- {v}_{i} \leq 0 ∀ i .$$

Another important requirement implemented as a hard constraint is the requirement to avoid collision with other agents of the scenario. Both static and dynamic agents of the scenario are characterised using ellipses, and collision is considered to have occurred if the ego trajectory enters the ellipse of another agent. One way to compute a collision constraint is to define an ellipse for the ego vehicle and check for collisions by checking if the ego ellipse overlaps with any of the ellipses of the other agents of the scenario.

As mentioned above, the contribution of the visibility term to the cost function ƒ_{occ}(x, y) varies as a function of the position of the ego vehicle, dependent on an occlusion map [symbol] (x, y) which is a function that maps ego position to a scalar that represents the level of occupancy at that position. The ego vehicle is provided with a 360° sensor (e.g. a Lidar sensor) mounted on the ego vehicle's centre. The computation of the occlusion map will now be described in further detail, with reference to FIG. 6.

FIG. 6 shows three diagrams of a scenario where an ego vehicle 200 is travelling behind a static agent 202. For each agent in the driving scenario that is visible by the ego agent 200 at time t=0, occluded polygons (‘shadows’) are computed for each position of the ego vehicle 200 on a grid discretisation of the reachable set of ego states in the planning horizon (Ω [symbol] ), as shown in FIGS. 6(a) and 6(b). The area of the union of the occluded polygons is computed for each point on the grid. This yields a discrete occlusion map [symbol] (x, y) in the real-world reference frame. The grid points are projected into the path-based reference frame associated with the position of the ego vehicle at t=0, yielding a discrete occlusion map in the path-based reference frame, before applying bilinear interpolation to build a continuous and differentiable occlusion map [symbol] (x, y). The occlusion map [symbol] (x, y) is employed to derive a continuous and differentiable cost term ƒ_{occ} as defined above, to be minimised together with other terms within the optimisation framework.

FIGS. 6(a) and 6(b) show the computation of occlusion polygons (shadows) for two different possible positions of the ego vehicle (x1, y1), (x2, y2). In order to compute the polygons from any given position within the reachable driveable surface Ω [symbol] , the surface is discretised into a grid of H×K cells. For each cell (h, k) and obstacle aᵢ the shadow Sᵢ(h, k) is computed by intersecting lines of sight from the centre of the cell (h, k) through corners of aᵢ with the layout, as shown in FIGS. 6(a) and 6(b). Only the polygons that are big enough to fit an occluded agent are kept. This may be determined based on a model of possible occluded agents. For example, in some applications, it may be assumed that all agents are vehicles, and a minimum dimension of a vehicle is used to determine which occluded regions possibly include a hidden agent. In other applications, other types of agents such as pedestrians or bicycles may be considered. In this case, a smaller threshold size is applied to the determined polygons. Then, all the remaining shadow polygons could contain an agent that can interact with the ego 200 within the planning horizon.

In FIGS. 6(a) and 6(b) the ego vehicle is shown as a circle instead of a rectangular box, with the centre point being the position from which the ego views the static agents 202a, 202b, based on the ego vehicle's sensor configuration. The sensor configuration is essentially collapsed into a single point from which lines of sights are projected to compute the occlusion regions as described above. Alternatively, if the relative position between the sensor configuration and the ego reference centre used in planning is known, the method can be adjusted accordingly. In FIG. 6(a), the ego vehicle 200 views the static agent 202a from a position directly behind it on the left side of the road. From this position the region of the road that is occluded, shown in black, is large enough to include a further occluded agent. In FIG. 6(b), the ego is positioned further along the road and further to the right, having a clear view of a larger portion of the road past the static agent 202a, as indicated by the reduced size of the shadow. The corresponding occluded region created by the occluding agent 202 from this ego position is relatively small, a polygon extending left from the front of the static occluding agent 202a. This region is too small to accommodate an occluded agent, as is the corresponding occluded region caused by the second static agent 202b. Therefore there are no contributions from the occluded regions to the occlusion map at this ego position (x₂, y₂) and the occluded area is 0 at this point.

For each cell (h, k) in the discretised spatial domain, the union U_{i∈I\J}Sᵢ(h, k) captures the total occluded area for the agents visible from the ego's position at (h, k). An agent is considered non-visible at (h, k) if its footprint βⱼ is fully contained in the shadow of a visible agent at that point:

$$J = \{ j ∈ I \vert ∃ v ∈ I : {S}_{v} ( h , k ) ⋂ {β}_{j} = {β}_{j} \}$$

where I is the set of all agents visible at t=0 and J is the set of all non-visible agents at (h, k).

The areas of the resulting union of shadows make the occlusion map [symbol] (h, k)=A (h, k). An alternative implementation could be based on raytracing and z-buffering which is highly parallelisable and can be hardware accelerated.

The resulting occlusion map in the real-world reference frame is shown as a gradient map over the reachable driveable area in FIG. 6(c). Darker regions correspond to higher occluded areas, with white areas indicating that when the ego is positioned in that region, there are no occlusions large enough to contain occluded agents. As shown, there is a large white region in the central portion of the driveable region, where an ego vehicle has a view of the scene such that no further agents could be fully contained in occluded regions of the driveable area. Darker portions are shown directly behind each of the agents 202a, 202b, since when the ego is positioned directly behind either of the static agent, the occluded region in front of that agent is large enough for another agent to be fully contained within it.

The spatial grid generated in the real-world reference frame is projected onto the path-based reference frame [symbol] _{ref} with the transformation [symbol] . Each projected vertex (h, k) [symbol] _{ref} is associated with its shadow area A(h, k) computed as described above in the real-world frame of reference. This is done because the projection [symbol] is not a Euclidean transformation, hence areas are not preserved but spatial neighbouring is. To achieve a differentiable function of the continuous spatial domain Ω [symbol] _{_{ref}}, bilinear interpolation of the area values at the vertices of the projected grid is employed, yielding a differentiable map [symbol] (x, y) in the path-based frame of reference.

A cost term is derived from the occlusion map to be minimised jointly with the other soft constraints in the optimisation problem. Every monotonically decreasing function of would comply with the requirement above and would encourage directions of decreasing occlusion, i.e. increasing visibility. To escape regions with low gradients (flat portions of the cost surface) the gradient is amplified by means of an exponential mapping of the normalised occlusion area.

FIG. 6(c) shows a gradient map indicating the contribution of the occluded area to the cost function, which is directly based on the area of the occluded region shown for the ego vehicle in that position. When planning a trajectory, the occluded area for each of the future ego states along that trajectory is evaluated and contributes to the visibility cost term ƒ_{occ} as defined above, so as to learn an ego trajectory that improves visibility so as to enable the ego to plan more safely at future timesteps.

As described above, the visibility cost term takes the form:

$${f}_{o c c} ( x , y ) = {w}_{o} exp \frac{{𝒪}_{𝒫} ( x , y ) - \underline{o}}{\overline{o} - \underline{o}}$$

where

$$\overline{o} = {max}_{x , y} {𝒪}_{𝒫} ( x , y ) , \underline{o} = {max}_{x , y} {𝒪}_{P} ( x , y )$$

are the maximum and minimum areas of the occlusion map to normalise the cost function within its range, and wₒ is the weight assigned to the occlusion cost term within the overall cost function [symbol] .

This term alone promotes exploration to improve visibility without taking into account the risk of agents potentially present in the occluded areas that might cause a conflict with the ego during this exploration. This is mitigated by an alternative formulation that penalises exploration once a certain percentage of the occluded area has become visible. Defining the normalised visibility \tilde{V} as:

$$\tilde{V} ( x , y ) = 1 - ( \frac{{𝒫}_{𝒫} ( x , y )}{\overline{o}} )$$

Then an alternative threshold-based cost term can be defined as:

$${f}_{o c c}^{vis \_ thld} ( x , y ) = {w}_{o} exp ( sign ( \tilde{V} ( x , y ) - ξ ) \tilde{V} ( x , y ) )$$

where ξ is the threshold percentage of visible occluded area above which the cost function no longer incentivises exploration. As 0≤\tilde{V}(.,.)≤1, then

$${w}_{o} {e}^{- 1} \leq {f}_{o c c}^{vis \_ thld} ( . , . ) \leq {w}_{o} e ,$$

and the threshold-based cost term decreases as the visibility increases up to the visibility threshold ξ, then increasing if the exploration is continued, essentially penalising further exploration once a given threshold visibility is reached. The threshold is determined as a heuristic, balancing the need for a degree of visibility suitable for planning trajectories as well as the potential risk in trajectories that aim to increase visibility.

The above description and FIGS. 3-6 refer to example implementations in which occluding objects are treated as static. In real-world scenarios, however, both static and dynamic occluding objects may be present. Dynamic occluding agents may be handled in the same way as described above for static objects, except that an occlusion map is computed for the different ego positions over each future state of the dynamic agents based on their predicted trajectories, rather than computing a single occlusion map giving the occluded area for different positions of the ego vehicle as shown in FIG. 6.

The term ‘predicted occluded region’ as used herein refers to the occluded region associated with any future ego state as part of an ego trajectory considered by the planner. For dynamic occluding vehicles, the predicted occluded region associated with a candidate ego trajectory differs for different predicted states of the occluding vehicle as well as different future states of the ego vehicle.

As mentioned above, the two-stage method of constrained optimisation, consisting of an initial linear optimisation stage to produce a first trajectory to initialise a second non-linear optimisation stage to solve the full optimisation problem of planning a safe trajectory to satisfy multiple hard constraints, is only one example optimisation-based planning approach, and other types of planners can be used to determine safe and comfortable trajectories towards planning goals. For example, a single non-linear constrained optimisation may alternatively be used. Furthermore, either or both of the MILP or NLP stages of the two-stage optimisation method may be implemented by a function approximator trained to approximate a MILP or NLP solver. Such an architecture is described in International Patent Publication No. WO2021/152047, which is herein incorporated by reference in its entirety. In another alternative architecture, an initialisation to the second-stage optimisation can be generated using a heuristic to generate a trajectory based on the road layout and states of other agents. One example initialisation could be provided by applying raised cosine function to generate an overtake path in appropriate scenarios, for example where the scenario contains static parked vehicles.

The planning method is performed iteratively over multiple timesteps, at each timestep taking the ego's current state as well as current and predicted states of other agents of the scenario and other scenario parameters as inputs, and using these to solve the optimisation problem using the chosen constrained optimisation architecture. An optimal set of control outputs is determined from the optimisation that corresponds to a desired ego trajectory that satisfies the hard constraints of the problem while optimising the soft constraints to the extent possible.

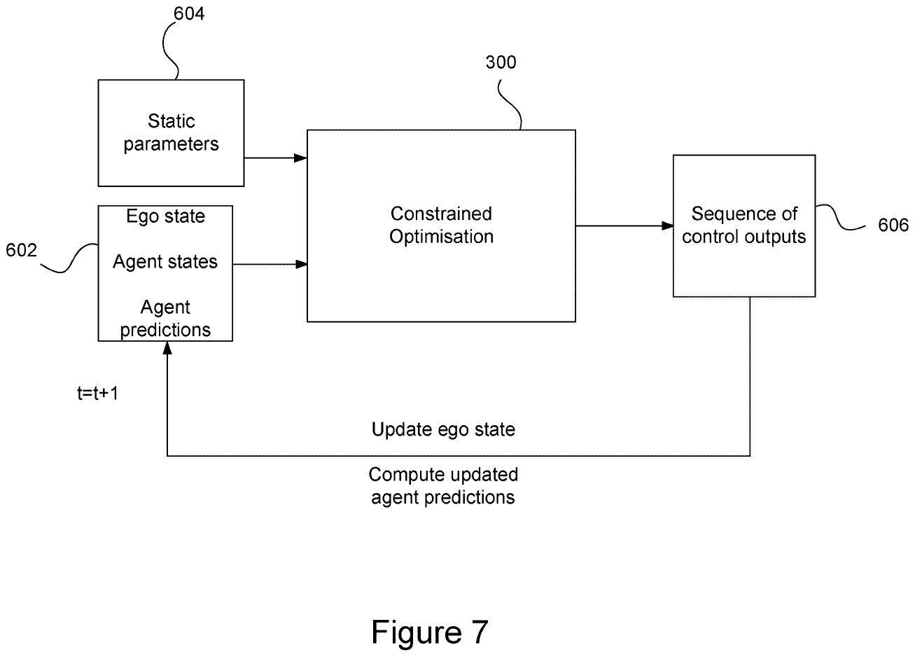

FIG. 7 shows a schematic block diagram of the process of planning an updated ego trajectory at each time t of a time sequence of planning steps, for a constrained optimisation architecture 300 that takes dynamic scenario parameters including ego and agent states for the given timestep, and predicted states of the other dynamic agents of the scenario, as well as static parameters 604 of the driving scenario, such as road layout parameters, ego vehicle dimensions, positions of static objects, etc., as inputs and outputs a set of control parameters 606 that define a desired ego trajectory based on the constraints of the optimisation problem.

The static parameters 604 in the examples described above include the occluded area values for different possible ego positions within the drivable region, based on the static positions of the occluding agents. The above examples assume that a static obstacle causes the occlusions, which means that the map of occluded areas can be computed once for the given section of road, without needing to be recomputed at later timesteps based on an updated state of the occluding agent.

However, the same method can be extended to include dynamic occluding agents. In this case, the occluding agent's state is included as a dynamic parameter, and a predicted trajectory is generated for the occluding agent at each timestep. Occluded areas for different possible ego positions of the drivable area would need to be computed at every timestep based on the predicted future states of the occluding agent. This requires multiple occlusion area ‘maps’ to be computed at each timestep (i.e. the occluded area for each possible position of the ego vehicle needs to be computed for different future predicted locations of the occluding agent), since the visibility term of the cost function considers the area of the occluded region for each ego state throughout the planned trajectory, and so the predicted state of the occluding agent for each of those timesteps must be used to determine a corresponding occluded area ‘map’ such as that shown in FIG. 6(c).

As described above with reference to FIGS. 5A and 5B, dynamic occluded objects are modelled by treating the occluded region as a virtual agent, and extending the virtual agents along the allowable paths based on a speed range determined for any hidden objects within that occluded region. At t=0, the occluded region is determined and an occlusion ellipse is defined for each occluded lane as described above. For later timesteps within the planning horizon, these ellipses expand based on the speed range defined for each lane, and split at any junctions or intersections for which multiple paths exist from the given lane.

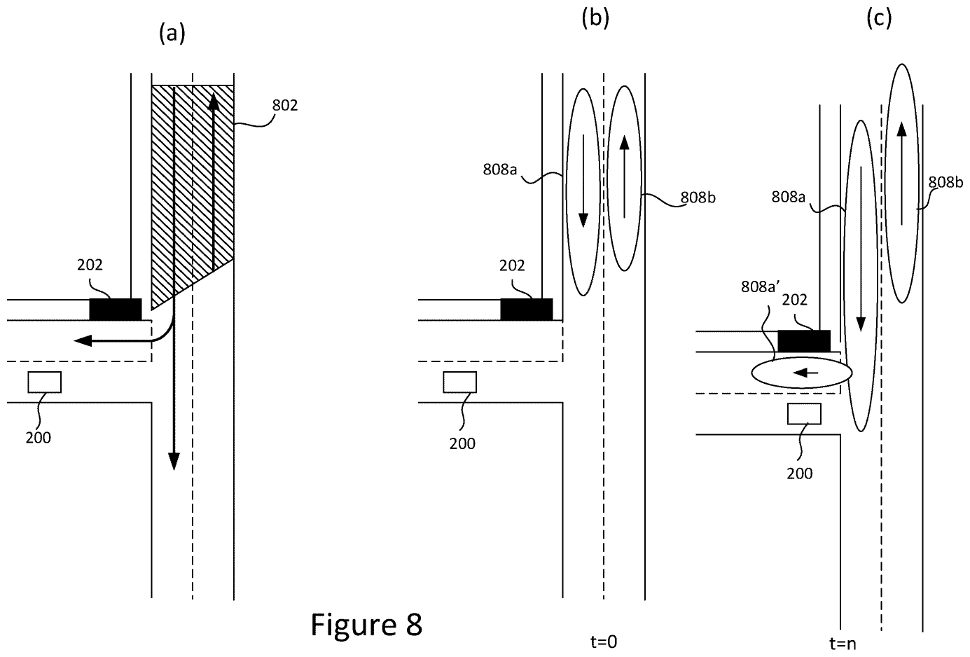

FIG. 8 shows an example junction scenario in which virtual agents are used to plan in the presence of occluding objects. FIG. 8(a) shows the ego vehicle 200 is travelling along the right lane of a road, approaching a T-junction, where it can turn right or left. The ego's view of the road to the left of the junction is obscured by a static occluding object 202. The occluded region 802 indicated by the shaded area is determined by ray-casting from the ego vehicle's centre and an occlusion map of the driveable area is determined as described above with reference to FIG. 6. As shown, the section of the ego's field of view on the left side of the road is occluded over both lanes. Three arrows are shown indicating three possible future routes of a hypothetical agent that is not visible to the ego vehicle 200 within the occluded region at t=0. Two virtual agents are generated, each corresponding to a respective lane, each represented by an occlusion ellipse 808a, 808b which is used by the planner to avoid collision in the cost function, as described above. Each virtual agent occupies a region for which any real agent located within that region would be invisible to the ego vehicle due to the occluding object 202. While the virtual agent is treated as a single moving object at any given timestep, it represents the range of possible locations of any real agents of the scene travelling in that lane. Real agents that are represented by the virtual agents, and which may or may not be present in the occluded region may also be referred to as ‘hypothetical’ agents. The virtual agents are represented by the ellipses 808a, 808b, each ellipse being defined within the given driving lane and having a length based on the length of the occluded region. However, it should be noted that other models of the agents may be used to define a shape and size for the region that may be occupied by an agent in order to avoid collision.

As the planner considers future timesteps over the planning horizon, the virtual agents move along their respective lanes within the predetermined speed range for that lane. As mentioned above, a conservative speed range has 0 as a minimum speed, while the maximum speed is determined based on the speed limit of the given lane, while a less conservative alternative sets the minimum speed to a more realistic driving speed along the lane as long as the ego has a sufficiently high time-to-collision with the virtual agent and can therefore execute an emergency braking manoeuvre once the virtual agent becomes visible. The direction of the agent is assigned according to the lane in which it is positioned.

FIG. 8(c) shows the same driving scenario a later timestep t=n within the planning horizon. The virtual agents 808a, 808b have expanded based on the motion of the virtual agent within the defined speed range. The front of each ellipse is the position of the agent at t=n assuming it drives at the maximum allowable speed for the given lane, while the back of each ellipse represents the position of the virtual agent assuming that it drives at the minimum allowable speed for that lane. Each ellipse 808a, 808b may be referred to as a predicted virtual agent collision region, since it represents the possible future locations of a hypothetical agent that occupies the current occluded region, based on the assumed motion of an agent in that region of the environment.

The ego has followed a partial candidate trajectory to move closer to the junction. However, it is important to note that within the planner, the only knowledge available to the ego is what was visible at t=0. Therefore the state of the virtual agents over the planning horizon is based only on the region that was occluded at t=0. However, the virtual agents at later timesteps of the planning horizon can extend beyond the region that was initially occluded. Even though the front of e.g. the ellipse 808a extends into an area that is visible at t=0, it still represents a ‘hidden’ agent, in that an agent that is currently invisible to the ego agent 200 could possibly occupy that position in the driving area at some future timestep. In addition to extending further along each lane of the occluded section of road, the virtual agent collision region 808a also splits to form a second virtual agent collision region 808a′, which turns to the right (from the point of view of the virtual agent itself), since this is a second possible future path of the virtual agent from its current lane, as indicated in FIG. 8(a). Again, while this position of the virtual agent is visible at the current timestep t=0, the virtual agent is ‘hidden’ in the sense that it represents a possible future location of an agent that is not currently visible.

As described above with reference to FIGS. 4-6, the cost function includes a visibility term based on the total occluded region 802 at t=0, which encourages the ego vehicle 200 to select trajectories that improve the overall visibility by reducing the size of occluded regions that could contain obstacles for the ego vehicle 200. Assuming that the goal of the ego agent 200 is to turn left at the junction, without any visibility term the ego would stop at the junction since it cannot progress towards the driving goal without colliding with either 808a or 808b. However, the visibility term encourages some exploration by the ego vehicle such that a trajectory can be planned in which it edges forward to get a view of the road to the left, and if it is found that no agents are present, or that any agents that are present are at a sufficient distance or moving at an appropriate speed to allow the ego vehicle to turn left. If the ego vehicle moves forward slightly to improve visibility, and finds that an agent is present and moving at such a speed that the turn manoeuvre can't be made immediately, there will still be sufficient time to avoid collision with the agent, since this is prevented by definition of the collision constraint on the virtual agents, provided that any agent that becomes visible is travelling within the speed range defined. It is therefore important to select an appropriate speed range that anticipates a range of possible agent behaviours, without being so broad as to make the ego's behaviour overly conservative.

Avoiding collision with the virtual agent can be encoded as either a soft constraint, where trajectories that lead to collision are penalised by a collision term within the trajectory cost function J, or as a hard constraint, where trajectories that lead to collision with the virtual agent, based on its predicted future states, are prohibited in the optimisation. Both hard and soft collision constraints can be tuned according to the given planning application, so as to balance conservatism to reduce safety risk with progress towards the planning goal.

Note that the scenario shown in FIG. 8(b), 8(c), and those shown on the right of FIG. 4, are merely illustrative examples of hypothetical scenarios that could be evaluated by the planner and they do not represent the actual events of a real-life driving scenario. In particular, for the current planning method using virtual agents, the agent 700 is not a real agent of the scenario but is generated to represent a possible real-life agent that may exist in an occluded region.

Preferred embodiments will now be described by way of example only.

### B. Occlusion Cost Term

To handle occlusions, the cost function [symbol] is augmented with an occlusion cost term that captures the level of occlusion for any possible location in the planning space (as perceived at time t=0). Added to the cost function with a suitable weight, this occlusion cost term encourages the planner to find compliant, comfortable and safe trajectories that also improve the visibility of ego as it progresses towards its goal.

The occlusion cost term depends on an occlusion map [symbol] : R²→R which is a function that maps ego position (x, y)∈ [symbol] to a scalar that represents the level of occupancy at that position. The ego vehicle is assumed endowed with a 360° Field of View (FOV) sensor (e.g. Lidar) mounted on the ego vehicle's centre (x, y).

The following steps are followed to compute the occlusion map:
For each visible vehicle aᵢ; i∈I, occluded polygons (or shadows) are computed for each position on a grid discretisation of [symbol]
The area of the union of the shadows associated to agents visible at t=0 is computed for each grid point. This stage yields the occlusion map [symbol] (x, y).
The grid points are projected onto the Frenet reference frame associated with the position of the ego vehicle at t=0. Bilinear interpolation is then employed to build the continuous and differentiable occlusion map [symbol] (x, y)
The occlusion map [symbol] is employed to derive a continuous and differentiable cost term to be minimised together with other terms within the optimisation framework.

### Baselines

In this section, baseline methods that handle occlusions differently are presented.

### A. Occlusion-Agnostic Planning

This baseline is equivalent to planning considering only the visible agents, i.e. ignoring completely the handling of occluded areas. This is unsafe in general.

### B. Occluded Areas as Stationary Hard Collision Constraints

An occluded area could be considered permanently occupied by a stationary obstacle that has the size of the occluded area in order to prevent ego from entering it, leading to very conservative planning. Collision avoidance regions are represented by ellipses, allowing an efficient formulation of the collision avoidance (quadratic) constraints and simplifying representing (Gaussian) uncertainties. This baseline is referred to as HARD_OCCL.

### C. Occluded Areas as Stationary Soft Collision Constraints

Occluded areas could be considered potentially occupied but, in order to avoid overly conservative behavior, can be represented as soft collision constraints. This will penalise the ego for approaching an occluded region without explicitly forbidding it. This approach is prone to collisions as it could allow ego to approach an occluded area without leaving enough reaction time in case a vehicle present in the occluded area becomes suddenly visible. This baseline is referred to as SOFT_OCCL.

### D. Ghost Agents

A more general treatment for occluded areas is to consider them occupied with dynamic agents moving within a range of possible speeds. While a common approach in the literature is to sample the positions and speeds of such dynamic agents from arbitrary distributions, we consider the full occluded area as a ghost agent that is traversing the layout. When the layout forks (e.g. at an intersection), the ghost agent splits into a number of ghosts that cover all the possible directions. To avoid sampling speeds, we consider the rear end of a ghost to be moving with the minimum speed of the speed range while the front moves with the maximum speed. This leads to expanding occluded areas that could be seen as the union of the reachable sets of all possible sampled agents and all possible speeds. These expanding areas could be considered hard or soft collision constraints. Setting the minimum and maximum speed to 0, in either case, leads to the two previous baselines, respectively.

1) Selecting the speed range: The conservatism of the planner that handles ghost agents depends on the chosen speed range. The safest, but the most conservative, choice would be to set the minimum speed to 0 and the maximum speed to the road speed limit. This, however, is not a reasonable assumption as it does not take into account the fact that the visibility of ego would change as it approaches the ghost area, nor that the planner might have additional chances to respond to potential threats that would appear in the future.

A more practical alternative is to set the minimum speed to 0 only when ego, travelling along the reference path, has a time-to-collision with the moving ghost area lesser than the time that will require ego to complete an emergency brake manoeuvre to avoid collision with that ghost from the future position where the closest point of the occluded ghost becomes visible. otherwise, with the knowledge that a contingency plan exists, the minimum speed could be set to some optimistic estimate, e.g. to the speed limit.

### Qualitative Results

A scenario is presented to show the behaviour arising from the different baselines with and without the occlusion term. In the scenario, referred to as T JUNCTION, the ego has to cross an unprotected T-junction almost totally occluded by an obstacle.

### B. T Junction

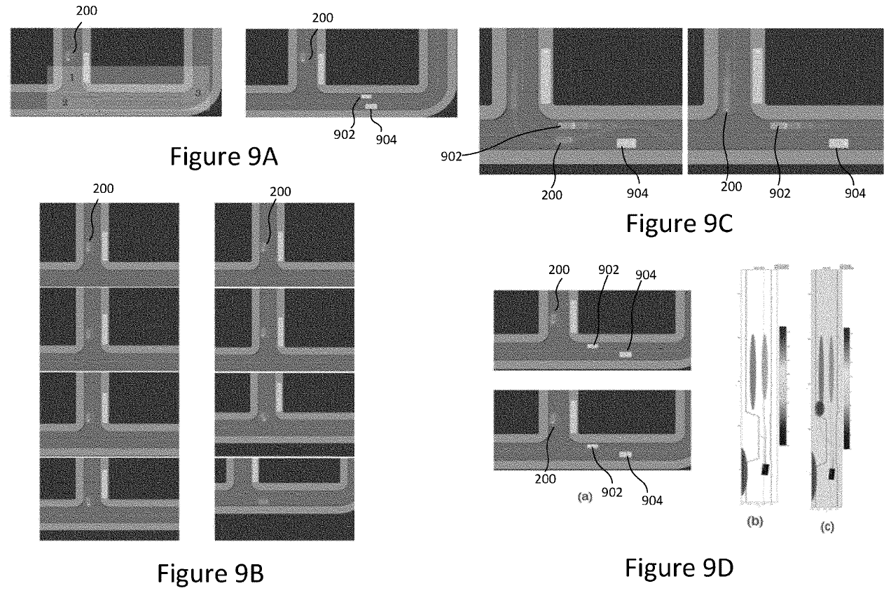

In FIG. 9A, left, the ego 200 has to turn left in an unprotected T-junction with its field of view initially occluded by an obstacle. Three ghost agents are spawned from the obstacle shadow corresponding to ego's initial position as shown in FIG. 9A: one ghost travelling along the ego lane (trace 3), and two ghosts travelling on the non-ego lane, one going straight across the intersection (trace 2) and the other turning right (trace 1). We refer to the scenario when there are no real vehicles in the shadows (FIG. 9A left) as T_JUNCTION_EMPTY.

For T_JUNCTION_EMPTY, depending on the range of the ghost agent's speed (in particular the maximum speed of ghost agent 2,

$${s}_{g}^{max} ) ,$$

different behaviours result when the occlusion term [symbol] is enabled. In this particular scenario, for

$${s}_{g}^{max} < 2.5 m / s$$

we observe a conservative behaviour with the ego 200 stopping before entering the junction regardless of the occlusion cost term in order to avoid collision with ghost agent 2. (FIG. 9B, left). For lower speeds when using the occlusion term, ego 200 nudges to the right to gain visibility and determine the absence of real vehicles much earlier, hence proceeding to cross the junction more assertively (FIG. 9B, right).

In FIG. 9A, right, an initiation of the T-junction scenario with two occluded vehicles 902, 904, a moving vehicle 902 traversing the junction on the non ego-lane at constant speed s_{dv}, and a parked vehicle 904 on the ego lane. This scenario is referred to as T_JUNCTION_2V. In FIG. 9C the planner's behaviors achieved for

$${s}_{d v} = 1. m / s , {s}_{g}^{max} = 2. m / s$$

without (left) and with (right) the occlusion term are shown. As

$${s}_{dv} < {s}_{g}^{max} ,$$

in both cases the GHOST_AGENTS baseline is conservative with respect to collisions, i.e. collision with respect to the real vehicles is already prevented by avoiding collision with the ghost agents. However, when the occlusion term is not used, the resulting behaviour looks overly cautious, as effectively the ego 200 waits until the dynamic vehicle has crossed the junction before committing to enter the junction. The occlusion term, on the other side, by encouraging exploration, allows the ego 200 to detect the dynamic vehicle 902 much earlier and cross the junction in a more natural way.

In FIG. 9D the behaviour achieved for T_JUNCTION_2V with

$${s}_{d v} = 2.1 m / s , {s}_{g}^{max} = 2. m / s$$

is illustrated. In this case the dynamic vehicle speed is outside the range assumed for the ghost agent, and even if the occlusion term is employed the visibility improvement might not be sufficient to detect the dynamic vehicle with sufficient advance to react in time, leading to collision (FIG. 9D(a)). FIG. 9D(b) shows the last successful plan before detection of the dynamic vehicle 902 (i.e., only taking into account ghost agents). As the vehicle is detected too late, subsequent plans (e.g. FIG. 9D(b)) cannot avoid collision with the dynamic agent 902.

The above techniques can be implemented in an “onboard” or “offboard” context. One example of an offboard context would be training of a planning component such as a neural network to approximate one or both of the optimisation stages described above, performed in an offboard computer system. The above techniques can also be implemented as part of a simulated runtime stack in order to test the performance of the runtime stack in a simulator. Simulation is an increasingly crucial component of safety and other performance testing for autonomous vehicles in particular.

References herein to components, functions, modules and the like denote functional components of a computer system which may be implemented at the hardware level in various ways. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). A computer system may be implemented “onboard” a mobile robot (such as an AV) or “offboard” for example in a simulator context.

1. A computer-implemented method of planning an ego trajectory for an ego robot in an environment in presence of an occluding object, the method comprising:
determining a trajectory cost function having one or more planning variables that define a planned ego trajectory, the planning variables tuneable to modify the planned ego trajectory, wherein the trajectory cost function is dependent on a predicted occluded region of the environment, as defined by the planned ego trajectory and a predicted state of the occluding object; and
tuning the planning variables using an optimiser applied to the trajectory cost function, wherein the trajectory cost function encodes: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from perspective of the ego robot, and thereby incentivising the optimiser to tune the planning variables in a manner satisfying the progress objective and the visibility objective.

2. A method according to claim 1, wherein the optimiser is a constrained optimiser that applies one or more hard constraints to the optimisation of the trajectory cost function, the hard constraints defining physical, safety, or comfort requirements for motion of the ego robot.

3. A method according to claim 2, wherein the hard constraints comprise at least:
a constraint for the ego trajectory to avoid collision with an external agents and/or road boundaries; or
a constraint that the planned ego trajectory avoids collision with a region defining possible locations of static or dynamic objects that are hidden by the occluding object at a current timestep.

4. (canceled)

5. A method according to claim 1, wherein the trajectory cost function further encodes a collision avoidance objective that rewards modifications to the planned ego trajectory that avoid collision with a region defining possible locations of static and/or dynamic objects that are hidden by the occluding object at a current timestep, whereby the optimiser is incentivised to tune the planning variables in a manner satisfying the progress, visibility and collision avoidance objectives.

6. A method according to claim 1, wherein the trajectory cost function further encodes one or more safety and/or comfort objectives, wherein the optimiser is incentivised to tune the planning variables in a manner satisfying the progress, visibility, safety and comfort objectives.

7. A method according to claim 1, wherein the visibility objective is based on a computed area of the predicted occluded region.

8. A method according to claim 7, implemented for planning an ego trajectory for an ego robot in an environment in the presence of multiple occluding objects, wherein the trajectory cost function is dependent on a predicted occluded region defined for each occluding object based on the planned ego trajectory and a predicted state of that occluding object, wherein the visibility objective is based on a computed total area of the respective predicted occluded regions associated with each occluding object.

9. (canceled)

10. A method according to claim 8, wherein any occluded region whose dimensions do not meet a predefined threshold for containing an occluded agent does not contribute to the computed total area of the predicted occluded regions.

11. A method according to claim 1, wherein the planned ego trajectory is generated for a planning horizon of N future timesteps and comprises a sequence of N+1 ego states, each ego state corresponding to a respective timestep within the planning horizon.

12. A method according to claim 11, wherein the planning variables comprise ego control variables for controlling motion of the ego robot at each of the N future timesteps.

13. (canceled)

14. A method according to claim 1, wherein the occluding object is a static object, and the predicted state of the occluding object is the state of the occluding object at a current timestep.

15. A method according to claim 1, wherein the occluding object is a dynamic object, and the predicted state of the occluding object is determined using a prediction component of the ego robot, based on a state of the occluding object at a current timestep.

16. A method according to claim 1, comprising predicting a virtual agent occlusion region based on a currently occluded region, wherein the optimisation of the trajectory cost function is performed so as to avoid collision with the virtual agent occlusion region.

17. A method according to claim 16, wherein the optimisation of the trajectory cost function is performed so as to avoid collision with the predicted virtual agent occlusion region by:
encoding in the cost function a collision objective that rewards modifications to the ego trajectory that avoid collision with the predicted virtual agent occlusion region; or
applying a hard constraint for the ego trajectory to avoid collision with the predicted virtual agent occlusion region, the hard constraint defining physical, safety, or comfort requirements for motion of the ego robot.

18. (canceled)

19. A method according to claim 16, wherein the predicted virtual agent occlusion region is determined by applying a virtual agent dynamics model defining a range of possible speeds of a virtual agent to the currently occluded region.

20. A method according to claim 1, comprising computing an initialisation trajectory, wherein the optimizer optimiser tunes the planning variables based on the initialisation trajectory.

21. A method according to claim 20, wherein the initialisation trajectory is computed by:
optimising, by a first-stage optimiser, a simplified trajectory cost function that encodes a simplified planning problem; or using a heuristic trajectory generation method.

22. (canceled)

23. A method according to claim 1, wherein the visibility objective is encoded so as to reward modifications to the planned ego trajectory that improve visibility of the environment from the perspective of the ego robot only when a computed visibility metric is below a predefined visibility threshold.

24. A computer system for planning an ego trajectory for an ego robot in an environment in presence of an occluding object, the computer system comprising:
computer-readable storage embodying computer-readable instructions; and
one or more hardware processors coupled to the computer-readable storage and configured to execute the computer-readable instructions which, upon execution, cause the one or more hardware processors to:
receive a predicted state of the occluding object;
tune, using an optimiser, one or more planning variables defining a planned ego trajectory, by optimising a trajectory cost function which is dependent on a predicted occluded region of the environment, as defined by the planned ego trajectory and a predicted state of the occluding object, the trajectory cost function encoding:
(i) a progress objective that rewards modifications to the planned ego trajectory that progress the ego robot towards a chosen goal location, and
(ii) a visibility objective, dependent on the predicted occluded region, that rewards modifications to the planned ego trajectory that improve visibility of the environment from perspective of the ego robot;
wherein the optimiser is configured to tune the planning variables in a manner satisfying the progress objective and the visibility objective.

25. A non-transitory medium embodying machine-readable instructions which, when executed on one or more computer processors, cause the processors to plan an ego trajectory for an ego robot in an environment in presence of an occluding object, by:
determining a trajectory cost function having one or more planning variables that define a planned ego trajectory, the planning variables tuneable to modify the planned ego trajectory, wherein the trajectory cost function is dependent on a predicted occluded region of the environment, as defined by the planned ego trajectory and a predicted state of the occluding object; and
tuning the planning variables using an optimiser applied to the trajectory cost function, wherein the trajectory cost function encodes: (i) a progress objective that rewards modifications to the planned ego trajectory that progress the ego robot towards a chosen goal location, and (ii) a visibility objective, dependent on the predicted occluded region, that rewards modifications to the planned ego trajectory that improve visibility of the environment from perspective of the ego robot, and thereby incentivise the optimiser to tune the planning variables in a manner satisfying the progress objective and the visibility objective.
